(19) United States
(12) Patent Application Publication
(10) Pub. No.: US 2007/0293959 A1
(43) Pub. Date: Dec. 20, 2007

(54) Apparatus, method and computer product for predicting a price of an object

(75) Inventors: Kunio Takezawa, Ibaraki (JP); Teruaki Nanseki, Ibaraki (JP)

Correspondence Address: FOLEY AND LARDNER LLP;SUITE 500, 3000 K STREET NW, WASHINGTON, DC, 20007, US

(73) Assignee: INCORPORATED ADMINISTRATIVE AGENCY NATIONAL AGRICULTURAL AND BIO-ORIENTED RESEARCH ORGANIZATIO

(21) Appl. No.: 11/889,774

(22) Filed: Aug. 16, 2007

Related U.S. Application Data
(62) Division of application No. 10/938,739, filed on Sep. 13, 2004.

(30) Foreign Application Priority Data
Oct. 31, 2003 (JP) 2003-372638

(51) Int. Cl. G05B 13/02

(52) U.S. Cl. 700/44

(57) ABSTRACT

A prediction apparatus that creates a prediction model using learning data, and calculates a prediction value using the prediction model, includes a model creating unit that creates a plurality of prediction models using the learning data, a residual-prediction-model creating unit that creates a residual prediction model that predicts a residual prediction error for each of the prediction models created, and a prediction-value calculating unit that combines first prediction values predicted by each of the prediction models, based on the residual prediction error predicted, to calculate second prediction value.

### CROSS-REFERENCE TO RELATED APPLICATIONS

This application is a divisional of U.S. patent application Ser. No. 10/938,739, filed Sep. 13, 2004, which is based upon and claims the benefit of priority from prior Japanese Patent Application No. 2003-372638, filed Oct. 31, 2003, the entire contents of which are incorporated herein by reference.

### BACKGROUND OF THE INVENTION

1) Field of the Invention

The present invention relates to calculating a prediction value by creating a prediction model using data learning.

2) Description of the Related Art

Examples of a conventional method of predicting by creating a prediction model using data leaning are shown in FIGS. 14A and 14B.

FIG. 14A is a schematic for explaining a prediction technique employing a single prediction model. In this approach, a plurality of prediction models are created by using different algorithms A, B, and C, and a prediction value is calculated from each of the prediction model. The prediction values are then compared with the actual data to decide which of the prediction value better matches with the actual data. A prediction model whose prediction values better matches with the actual data is used for an actual prediction.

There are various methods of prediction using a single prediction model, such as CART® (Classification And Regression Trees), MARS® (Multivariate Adaptive Regression Splines), TreeNet™, and Neural Networks (see, for example, Atsushi Ohtaki, Yuji Horie, Dan Steinberg, “Applied Tree-Based Method by CART”, Nikkagiren publisher, 1998, Jerome H. Friedman, “MULTIVARIATE ADAPTIVE REGRESSION SPLINES”, Annals Statistics, Vol. 19, No. 1, 1991, Dan Steinberg, Scott Cardell, Mikhail Golovnya, “Stochastic Gradient Boosting and Restrained Learning”, Salford Systems, 2003, and Salford Systems, “TreeNet”, Stochastic Gradient Boosting, San Diego, 2002).

When a plurality of prediction models having various characteristics can be created by adjusting parameter values that adjusts the characteristics of an algorithm, although the algorithm is a single prediction model, a prediction model is obtained by comparing prediction values with actual data to optimize the parameter values.

FIG. 14B is a schematic for explaining a prediction method that combines a plurality of prediction models. In this technique, a prediction model is created by using a specific model-creation algorithm. A residual-difference prediction model is created by applying residual difference of the prediction model from the actual data to another model creation algorithm. Then sum of the values created by the prediction model and the residual-difference prediction model or other similar values are used as prediction values. Such a prediction method is called “a hybrid model” (see, for example, Tetsuo Kadowaki, Takao Suzuki, Tokuhisa Suzuki, Atsushi Ohtaki, “Application of Hybrid Modeling for POS Data”, Quality, Vol. 30, No. 4, pp. 109-120, October 2000).

However, the conventional technique employing a single prediction model is based on an assumption that the characteristic of the data is uniform over the entire data space. Therefore, if the characteristic of the actual data is not uniform, appropriate prediction values cannot be obtained.

On the other hand, better results are obtained in the hybrid model because the technique is benefited from the advantage of each prediction model used. However, even in the hybrid model, it is likely that appropriate prediction values can hardly be obtained if the characteristic of the data space has a regional variation.

### SUMMARY OF THE INVENTION

It is an object of the present invention to solve at least the above problems in the conventional technology.

The prediction apparatus according to one aspect of the present invention includes a model creating unit that creates a plurality of prediction models using learning data, a residual-prediction-model creating unit that creates a residual prediction model that predicts a residual prediction error for each of the prediction models created, and a prediction-value calculating unit that combines first prediction values predicted by each of the prediction models, based on the residual prediction error predicted, to calculate second prediction value.

The method of creating a prediction model according to another aspect of the present invention includes creating a plurality of prediction models using learning data, creating a residual prediction model that predicts a residual prediction error for each of the prediction models created, and combining first prediction values predicted by each of the prediction models, based on the residual prediction error predicted, to calculate second prediction value.

The computer program according to still another aspect of the present invention realizes the method according to the above aspect on a computer.

The computer readable recording medium according to still another aspect of the present invention stores the computer program according to the above aspect.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic for explaining a prediction algorithm for a prediction apparatus according to an embodiment of the present invention;

FIG. 2 is a block diagram of the prediction apparatus according to the embodiment;

FIG. 3 is a flowchart of an operation of the prediction apparatus;

FIG. 4 is a list of data items used to predict house prices in a residential area in Boston;

FIG. 5 is a table of number of data used to predict house prices in the residential area in Boston and to evaluate a result of the prediction;

FIG. 6 is a table of an evaluation of the prediction of house prices in the residential area in Boston using the prediction apparatus according to the embodiment;

FIG. 7 is a list of data items used to predict radish prices at Ohta market;

FIG. 8 is a table of data sets created for an evaluation based on data pertaining to radish prices at the Ohta market for eight years;

FIG. 9 is a graph of a result of the prediction by the prediction apparatus according to the embodiment;

FIG. 10 is a table for comparing prediction accuracy based on a bandwidth between a combined model used in the prediction apparatus according to the embodiment and a single model;

FIG. 11 is a table of a result of robustness analysis for the prediction apparatus according to the embodiment;

FIG. 12 is an analysis-of-variance table based on a randomized blocks method;

FIG. 13 is an analysis-of-variance table based on the randomized blocks method when blocks are modified;

FIG. 14 A is a schematic for explaining a prediction method using a single prediction model; and

FIG. 14B is a schematic for explaining a prediction method combining a plurality of prediction models.

### DETAILED DESCRIPTION

Exemplary embodiments of a prediction apparatus, a prediction method, and a computer product according to the present invention will be explained in detail below with reference to the accompanying drawings.

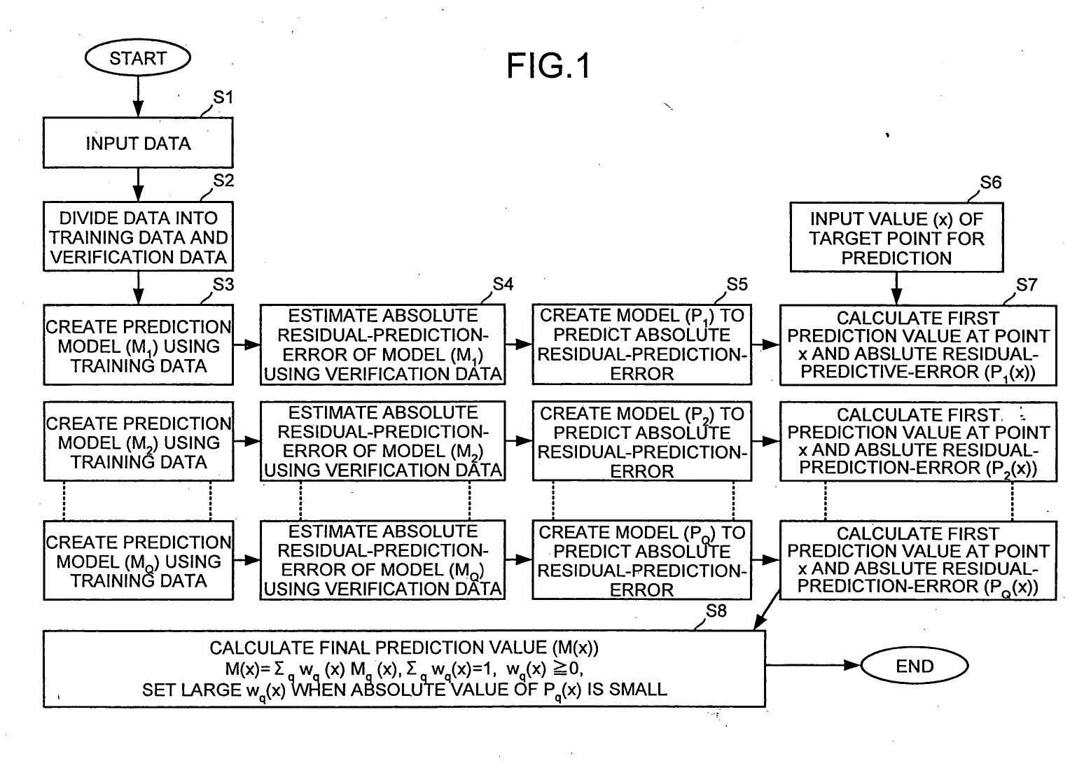

FIG. 1 is a schematic for explaining a prediction algorithm for a prediction apparatus according to an embodiment of the present invention. The prediction apparatus receives data (step 1) and divides the data into training data (learning data) and verification data (step 2).

The prediction apparatus then creates Q prediction models, i.e., prediction models M1, M2, . . . , MQ, by using the training data (step 3). The prediction apparatus then creates models P1, P2, . . . , PQ by using the verification data (steps 4 to 5). As explained later, these models P1, P2, . . . , PQ are used to predict absolute values of errors of prediction values (hereinafter, “absolute errors”) that are calculated from each prediction model M1, M2, . . . , MQ.

Precisely, the absolute errors d_{qi}=|yᵢ−M_{q}(xᵢ)|(1≦q≦Q) are calculated by applying the verification data ({xi, yj}, 1≦1≦n, where x1 is a predictor variable and it is a vector quantity, and yᵢ is a target variable and it is a scalar quantity) to the prediction models M1, M2, . . . , MQ. Then the models P1, P2, . . . , PQ are created by using ({xi, dqi}, 1≦i≦n, 1≦q≦Q).

Subsequently the prediction apparatus receives a value x at a target point for prediction (step 6) and calculates prediction values M1(x), M2(x), . . . , MQ(x) at the value x for each prediction model (hereinafter, “first prediction values”) and the absolute errors P1(x), P2(x), . . . , PQ(x) are calculated (step 7).

Then, M(x)=Σ_{q}w_{q}(x) M_{q}(x) as a second prediction value is calculated (step 8). Here, wq(x) is a weight that satisfies conditions Σ_{q}w_{q}(x)=1 and W_{q}(x)≧0, and a large weight is set to wq(x) when Pq(x) is small. For example, when the absolute error Pq(x) is the smallest, the above conditions are satisfied if “unity” is set to the weight wq(x) and “zero” is set to the other weights.

As explained above, the prediction apparatus calculates the first prediction values M1(x), M2(x), . . . MQ(x) by using the plurality of the prediction models M1, M2, . . . MQ. The apparatus further calculates the absolute errors P1(x), P2(x), . . . PQ(x). Then the apparatus calculates the second prediction value M(x) by performing weighting to the prediction values M1(x), M2(x), . . . MQ(x) in such a manner that the large weight is set to the prediction value Mq(x) with which a small absolute prediction value Pq(x) is obtained. By performing these processes, a combined model is created by combining the plurality of the prediction models to suit each value (x) and the prediction can be performed by the combined model.

For example, if “unity” is set to the weight of the prediction value Mq(x) with the smallest absolute prediction value Pq(x), and if “zero” is set to the weight of the other prediction values, the prediction can be performed by a prediction model Mq that is expected to give the smallest absolute residual error at value (x).

Further, in the above algorithm, the prediction models P1, P2, . . . PQ are created to predict the absolute errors of the prediction values that are calculated by the models M1, M2, . . . MQ. However, different models may be created as residual prediction models to predict prediction residuals, namely yᵢ-Mq(xᵢ).

In this case, the second prediction value can be calculated, for example, by setting a large value to the weight when the absolute error of the prediction values calculated by the residual prediction model is small. Alternatively, the second prediction value can be calculated as M(x)=Σ_{q}w_{q}(x) Mq(x)+Σ_{q}w_{q}(x)R_{q}(x), where R_{q}(X)(1≦q≦Q) is a prediction residual error given by the residual prediction model.

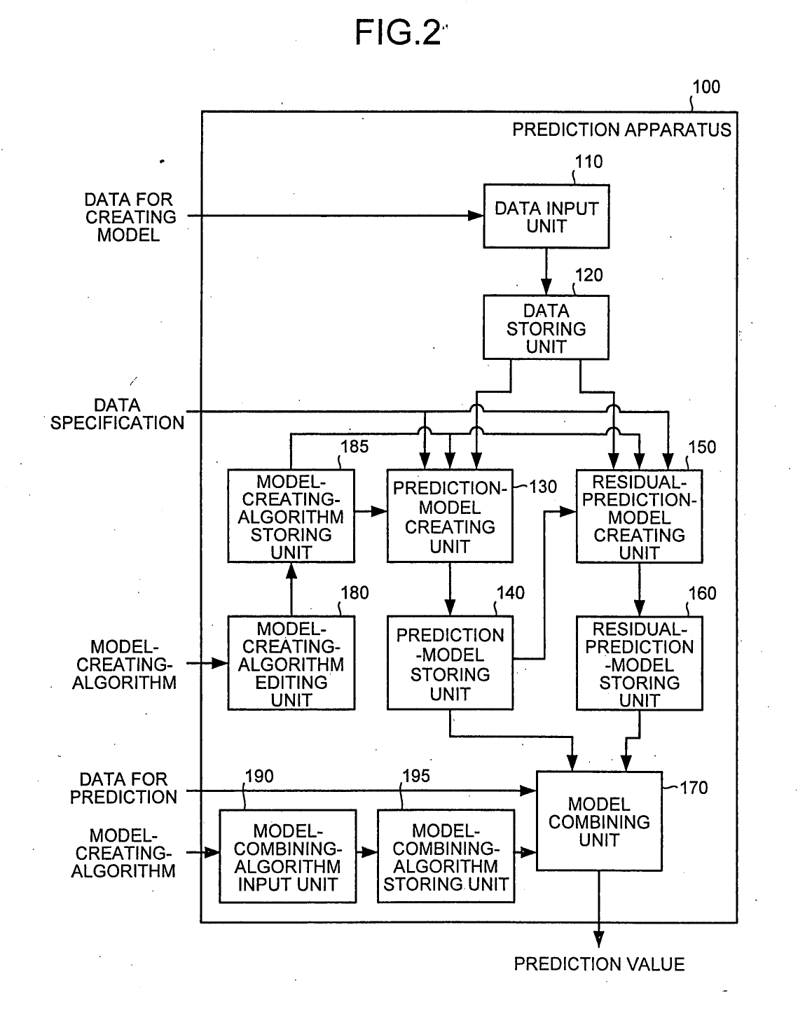

The prediction apparatus according to the present embodiment will be explained. FIG. 2 is a block diagram of the prediction apparatus according to the embodiment. The prediction apparatus 100 includes a data input unit 110, a data storing unit 120, a prediction-model creating unit 130, a prediction-model storing unit 140, a residual-prediction-model creating unit 150, a residual prediction-model storing unit 160, a model combining unit 170, a model-creation-algorithm editing unit 180, a model-creation-algorithm storing unit 185, a model-combination-algorithm input unit 190, and a model-combination-algorithm storing unit 195.

The data input unit 110 receives data to create the prediction models. The data input unit 110 sends the data to the data storing unit 120. The data storing unit 120 stores the data input by the data input unit 110. The data stored in the data storing unit 120 are used to create the prediction models and the residual models.

The prediction-model creating unit 130 creates a plurality of prediction models by using the data that are stored in the data storing unit 120, and sends the prediction models to the prediction-model storing unit 140. Here, a user may specify data, from data stored in the data storing unit 120, to be used as learning data.

The prediction-model storing unit 140 stores the prediction models that are created by the prediction-model creating unit 130. The prediction models stored in the prediction-model storing unit 140 are used for prediction.

The residual-prediction-model creating unit 150 creates a residual prediction model for each of the prediction models that are created by the prediction-model creating unit 130, to predict the residual prediction errors. The residual-prediction-model creating unit 150 sends the residual prediction models into the residual prediction-model storing unit 160.

The residual-prediction-model creating unit 150 creates the residual-difference prediction models to predict absolute values of the difference between the prediction values that are predicted by each prediction model and the actual values, based on data that are stored in the data storing unit 120 and that are different from data used to create the prediction models.

The residual prediction-model storing unit 160 stores the residual prediction models that are created by the residual-prediction-model creating unit 150. The absolute residual error of the first prediction value that is predicted by each prediction model can be predicted with the residual prediction models that are stored in the residual prediction-model storing unit 160.

The model combining unit 170 calculates the second prediction values by using the prediction models that are created by the prediction-model creating unit 130 and the residual prediction models that are created by the residual-prediction-model creating unit 150.

The model creating unit 170 calculates the first prediction values based on the predictive data (the value x of a target point for prediction) by using the plurality of the prediction models stored in the prediction-model storing unit 140. Further, the model creating unit 170 calculates the absolute error by using the predictive data by the residual prediction models that are stored in the residual prediction-model storing unit 160.

The second prediction value is calculated in a manner that a large weight is set to the first prediction value that are calculated by using the prediction model with which a small absolute value of the residual prediction error is obtained, and that the weight for each first prediction value is determined as sum of the all weights becomes “unity”.

For example, “unity” is set to the weight for the first prediction value with which a smallest absolute value of the residual prediction error is obtained, and “zero” is set to the other weights. Namely, the prediction model with which a smallest absolute value of the residual prediction error is obtained calculates the second prediction value.

The model combining unit 170 combines the first prediction values based on the absolute value of the residual prediction errors and calculates the second prediction value. In this process, the prediction model that suits to data for prediction can be combined and accurate prediction can be performed. The model-combining-algorithm input unit 190 can modify the algorithm for combining the first prediction values based on the absolute value of the residual prediction errors.

The model-creation-algorithm editing unit 180 inputs, deletes, and modifies the algorithm for the prediction model created by the prediction-model creating unit 130 and the residual-prediction-model creating unit 150. Namely, the number or kind of prediction models, which are created by the prediction-model creating unit 130 and the residual-prediction-model creating unit 150, may be changed by editing the algorithm with the model-creation-algorithm editing unit 180.

The model-creation-algorithm storing unit 185 stores the model creating algorithms that are edited by the model-creation-algorithm editing unit 180. The prediction-model creating unit 130 and the residual-prediction-model creating unit 150 read out the model-creating algorithm from the model-creation-algorithm storing unit 185 and create the prediction models.

The model-combining-algorithm input unit 190 receives the combining algorithm. The model combining unit 170 combines the second prediction values based on the plurality of the first prediction values by using the combining algorithm. That is, a method for calculating the prediction values by the model combining unit 170 may be changed by inputting the combining algorithm with the model-combining-algorithm input unit 190.

The model combining-algorithm storing unit 195 stores the model combining-algorithm input by the model-combining-algorithm input unit 190. The model combining unit 170 read out the model combining-algorithm from the model combining-algorithm storing unit 195 and calculates the second prediction values based on the first prediction values.

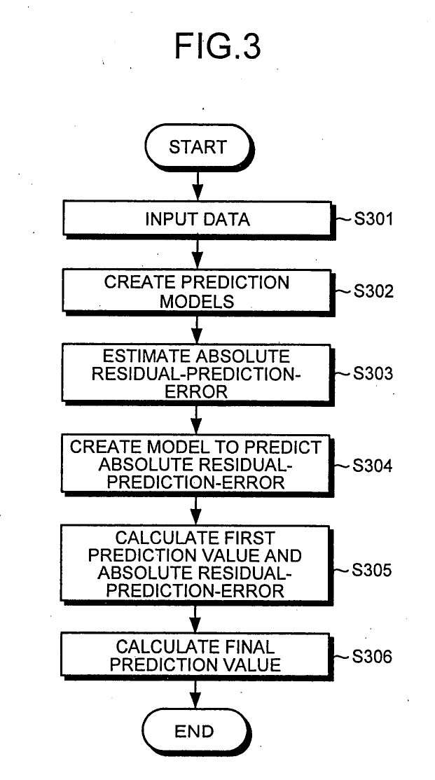

FIG. 3 is a flowchart of an operation of the prediction apparatus 100. In the apparatus 100, the data input unit 110 receives data (step 301) and sends the data into the data storing unit 120.

A plurality of the prediction models are created based on data that are specified by the user as training data from data that are stored by the data storing unit 120 (step 302). The prediction-model storing unit 140 stores the plurality of the prediction models. At this step, the prediction-model creating unit 130 creates the prediction models based on the model-creating algorithm that are stored in the model-creation-algorithm storing unit 190.

The residual-prediction-model creating unit 150 estimates the absolute value of a prediction error of each prediction model by using data specified by the user, from data stored in the data storing unit 120, as verification data (step 303). Then, the residual prediction models are created by using the absolute value of the prediction error and the verification data, and the residual prediction-model storing unit 160 stores the created residual prediction models (step 304).

After the data for prediction are given, the model combining unit 170 calculates the first prediction values by using the plurality of prediction models (step 305). Further the model combining unit 170 calculates the prediction values of the absolute errors by using the residual prediction models according to each prediction model (step 305). Then the second prediction value is calculated by combining the first prediction values of each model based on the prediction values of the absolute errors using the algorithm input by the model combining input unit 190 (step 306). The second prediction value is output (step 306).

As explained above, the model combining unit 170 combines the prediction value of each model based on the prediction values of the absolute errors and calculates the second prediction value, so that prediction can be performed in a manner that a plurality of models are combined according to data for prediction.

The evaluation results by the prediction apparatus 100 to predict house prices in residential area in Boston will be explained. Here, the prediction-model creating unit 130 creates four prediction models based on CART, MARS, TreeNet, and Neural Networks. In this case, the second prediction value that are determined by the model combining unit 170 is the first prediction value which is accompanied by the smallest prediction value of the absolute residual error. Here, data concerning house prices in Boston, 1978, by Harrison and Rubinfeld, are used to create models.

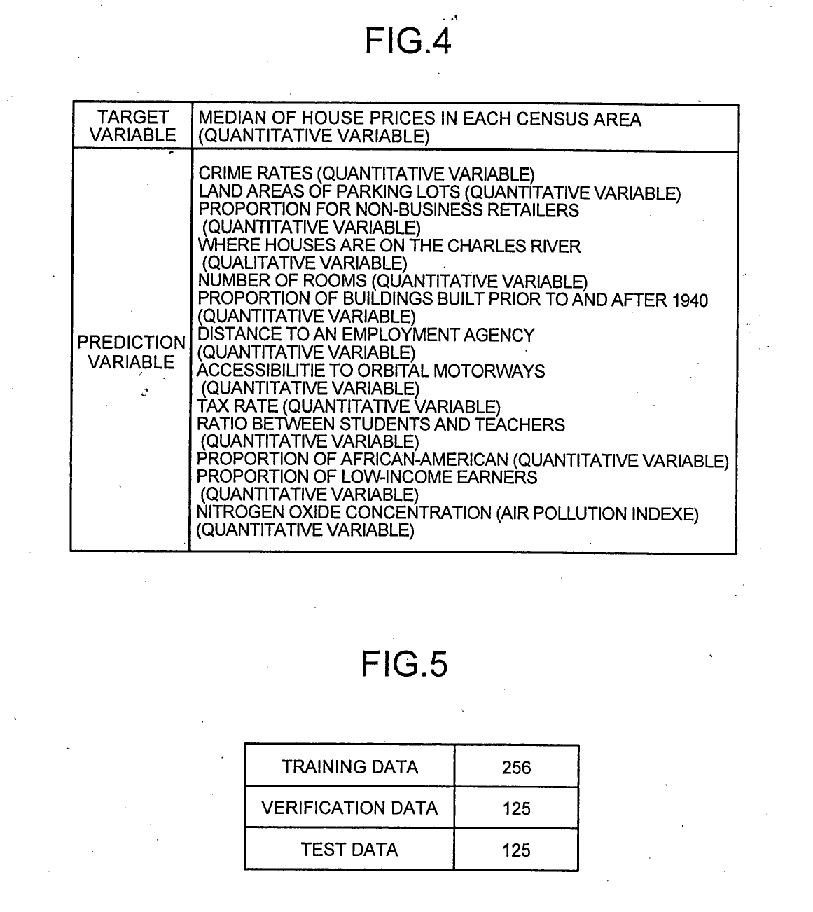

FIG. 4 is a list of data items used to predict house prices in a residential area in Boston. A target variable is a median of house prices that are divided based on census area. Prediction variables (explaining variables) are crime rate, land area of parking lots, proportion for non-business retailers, whether house are on the Charles River, number of rooms, proportion of buildings built prior to 1940, distance to an employment agency, accessibility to orbital motorways, tax rate, ratio between students and teachers, proportion of African-American, proportion of low-income earners, and nitrogen oxide concentration (air pollution index).

FIG. 5 is a table of number of data used to predict house prices in the residential area in Boston and to evaluate a result of the prediction. As shown in this figure, 256 data are used as training data, 125 data are used as verification data, and 125 data are used as test data.

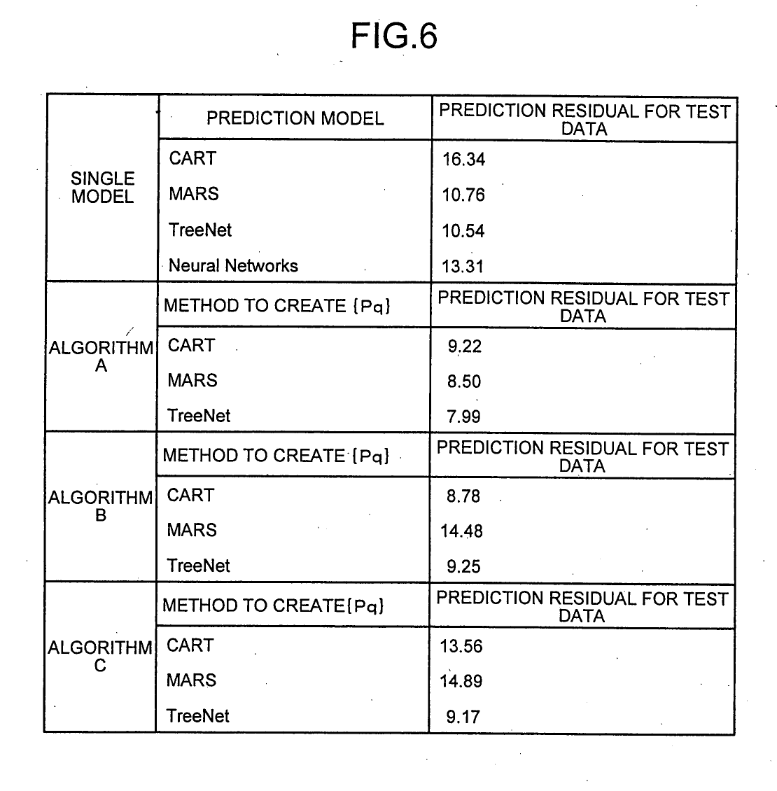

FIG. 6 is a table of an evaluation of the prediction of house prices in the residential area in Boston using the prediction apparatus 100. The line of “algorithm A” in the figure indicates the evaluation results by the prediction apparatus 100.

The line of “algorithm B” shows the evaluation results where the residual prediction models predict errors, and the second prediction value is the first prediction value that are calculated by the prediction model with which the smallest absolute value of the residual prediction error is obtained when the data for prediction are given. The line of “algorithm C” shows the evaluation results where the residual prediction models predict errors, the second prediction value is calculated by adding a first prediction value to a residual prediction error of the first prediction value, and the first prediction value is calculated by the prediction model with which the smallest absolute value of the residual prediction error is obtained when the data for prediction are given.

Each number in this figure is a variance of residuals according to the prediction model, the residual prediction model, and the combination method of the prediction value. For example, the variance of residuals for test data for the case of applying CART alone is “16.34”. The variance of residuals for test data for the case of prediction of absolute value of residuals, as residual predicting model, by the prediction apparatus 100 (CART in algorithm A), is “9.22”.

The evaluation result shows that algorithm A brings more accurate prediction values than values by any single model no matter which of CART, MARS, or TreeNet is used to create the residual prediction model.

Namely, the variance of residuals with algorithm A is “7.99 to 9.22”. This variance is smaller than the variance “10.54 to 16.34” of residuals with a single model.

The evaluation results of prediction of a radish price at Ohta market by the prediction apparatus will be explained. Here, the prediction-model creating unit 130 creates four prediction models based on CART, MARS, TreeNet, and Neural Networks. In this case, the second prediction value determined by the model combining unit 170 is the first prediction value with which the smallest prediction value of the absolute value of residual error is obtained. Data concerning the radish price at Ohta market for eight years from 1994 to 2001 are used to create and evaluate models.

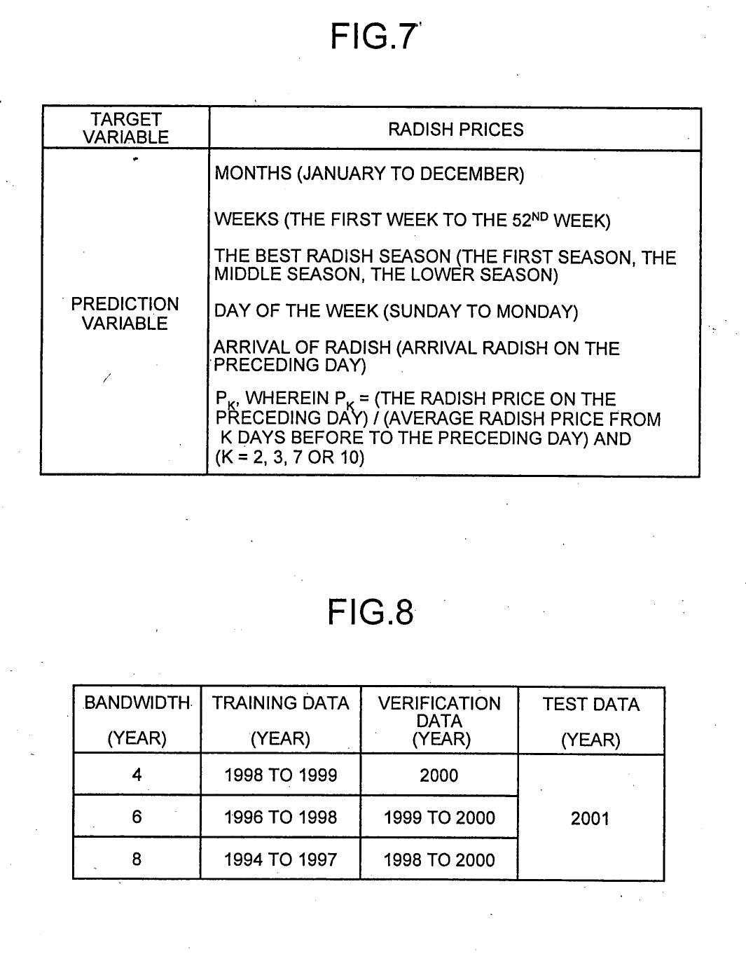

FIG. 7 is a list of data items used to predict radish prices at Ohta market. A target variable is the radish price. Prediction variable (explaining variables) are months (January to December), week (the first week to the 52nd weeks), the best radish season (the first season, the middle season, the lower season), a day of the week (Sunday to Monday), arrival of radish (arrival radish on the preceding day), and Pk, where Pk=(the radish price on the preceding day)/(average radish price from k days before to the preceding day) and k=2, 3, 7 or 10. The number of prediction variables is 9.

FIG. 8 is a table of data sets created for an evaluation based on data pertaining to radish prices at the Ohta market for eight years. During 1994 to 2001, the market had been under the influence of big economic fluctuation because of rupture of the speculative bubble economy. Therefore, data sets may receive some effect arising from data period (hereinafter, “bandwidth”) of data used for prediction by the model. Thus, three kinds of data sets, four years, six years, or eight years of bandwidth, are prepared herewith.

As shown in FIG. 8, one of the three kinds of data sets includes data for two years from 1998 to 1999 as training data and data for one year on 2000 as verification data. Another data set of the three kinds of data sets includes data for three years from 1996 to 1998 as training data and data for two years from 1999 to 2000 as verification data. The other data set of the three kinds of data sets includes data for four years from 1994 to 1997 as training data and data for three years from 1998 to 2000 as verification data. The data on 2001 are used as test data to evaluate the predictive results by the prediction apparatus 100.

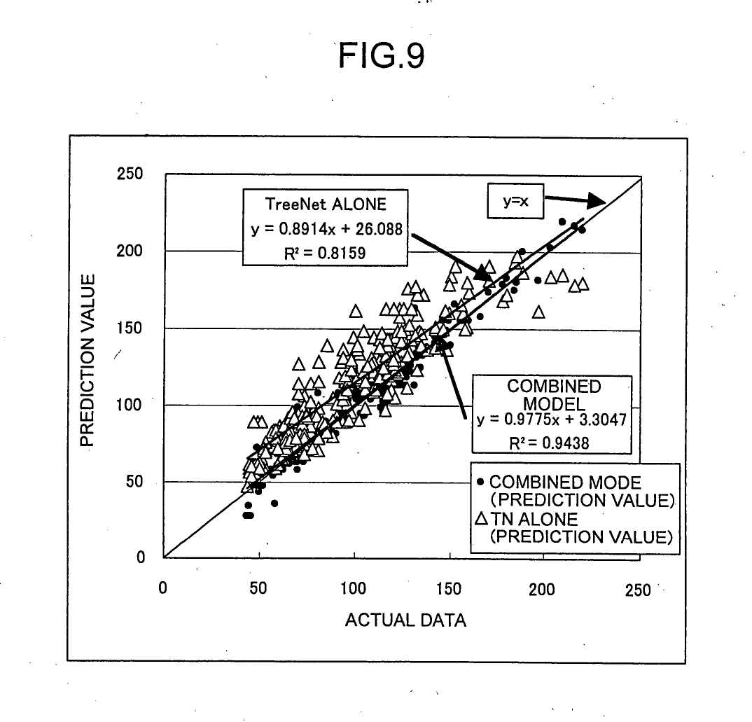

FIG. 9 is a graph of a result of the prediction by the prediction apparatus according to the embodiment. In this figure, prediction values predicted by the prediction apparatus 100 by using test data are plotted in vertical axis, and actual data are plotted in horizontal axis. Here, the data set used is data set with four years of bandwidth. This figure also shows, for comparison, the predictive results by TreeNet (TN) by which the most accurate prediction is performed rather than CART, MARS, or Neural Networks (NN).

It can be said from the verification of regression coefficient for the prediction apparatus 100 and TN alone that the slope of both methods is “unity”. However, an intercept by the prediction apparatus 100 passes through the origin of the figure, while an intercept by TN alone does not.

Therefore, it is found that TN model alone creates deviation. This deviation is caused because the prediction values are unsteady in chronological order. On the other hand, it can be said that the predictive apparatus 100 creates almost no deviation.

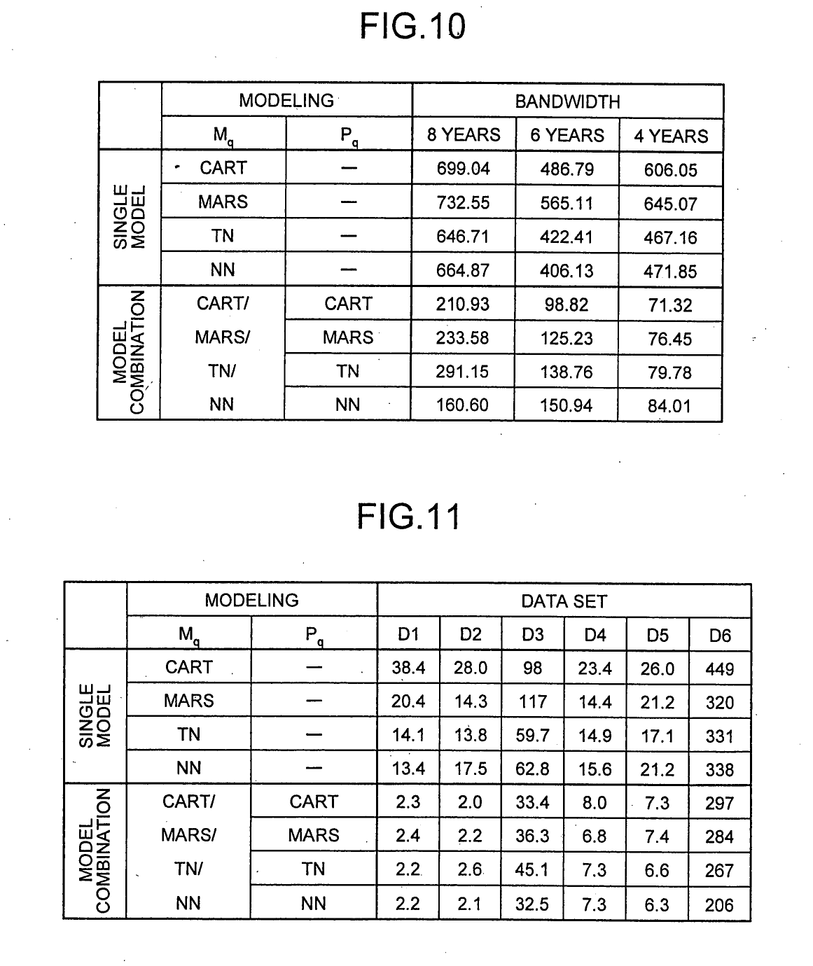

FIG. 10 is a table for comparing prediction accuracy based on a bandwidth between a combined model used in the prediction apparatus according to the embodiment and a single model. Each number of the figure indicates the variance of residuals that are predicted by model shown in each line and data set of bandwidth shown in each column. The part of “model combination” shows variance of residuals by the prediction apparatus 100.

From this figure, it is found that the results in all of bandwidths by the predictive apparatus 100 are more accurate than those by a single model. Further, the bandwidth gives certain influence to the results by the predictive apparatus 100. The results in four years of bandwidth are the most accurate among the all of results.

FIG. 11 is a table of a result of robustness analysis for the prediction apparatus according to the embodiment. This figure shows the variance of residuals for six data sets D1 to D6 by the predictive apparatus 100 and a single model. The part of “model combination” shows the results by the prediction apparatus 100. It is found from the results that the all of the results by the predictive apparatus 100 are more accurate than those by a single model.

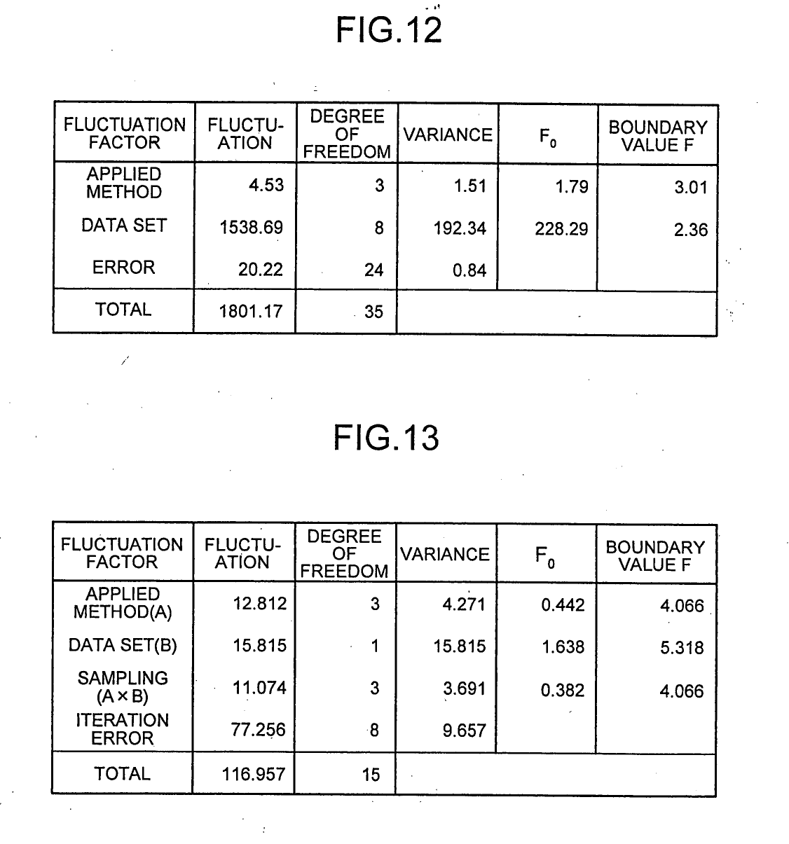

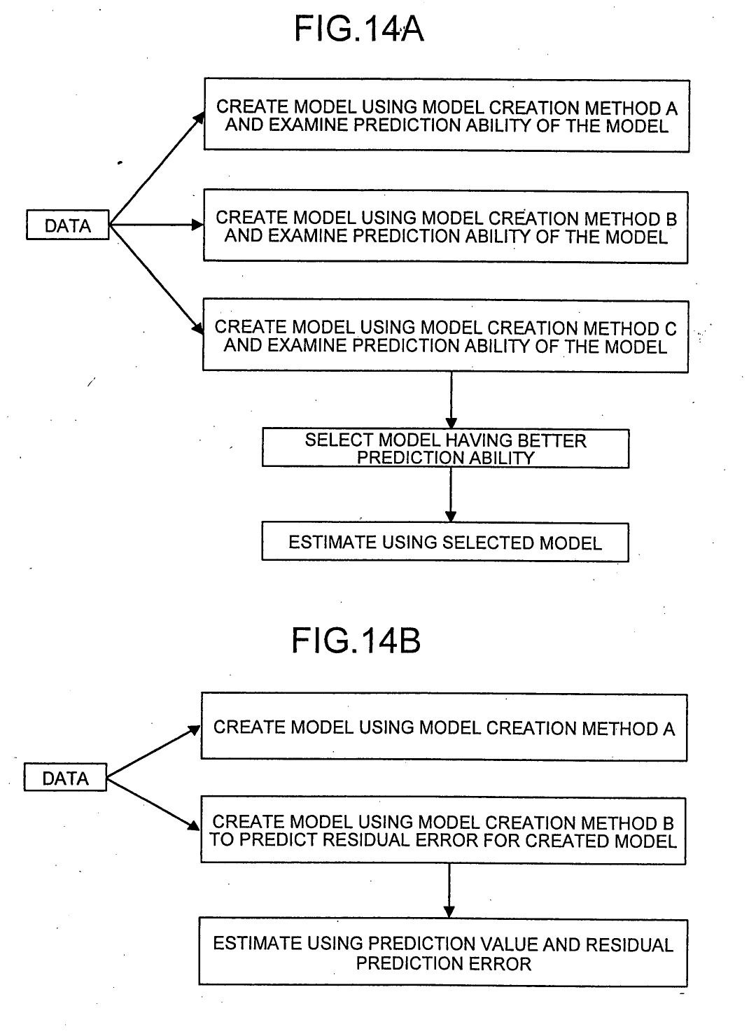

FIG. 12 is an analysis-of-variance table based on a randomized blocks method. In this figure, four model combinations are deemed as one factor, and nine data sets shown in FIGS. 10 and 11 are blocked. As analysis objects in here are variance of residuals, the analysis is performed with conversion to signal-to-noise ratio (SN ratio) to generate additivity in factorial effects.

As can be seen from the comparison of F0 with boundary value F, with regard to “applied techniques” in the figure, F0 is smaller than boundary value F. Thus it can be said that the difference between the applied techniques is not so large. On the other hand, with regard to “data sets”, F0 is larger than boundary value F and the difference between the data sets is large.

FIG. 13 is an analysis-of-variance table based on the randomized blocks method when blocks are modified. In the figure, as (D1, Ds), (D4, D5) merely repeats the sampling of the same data sets, the pair is analyzed as repetition in block. As shown in the figure, it can be said that each sampling does not bring different accuracy and proper sampling is performed.

As explained above, in the present embodiment, the prediction-model creating unit 130 creates a plurality of prediction models. The residual-prediction-model creating unit 150 creates a residual prediction model for each of the prediction models to predict an absolute value of the residual error. The model creating unit 170 calculates the first prediction values by the plurality of the prediction models, the absolute error by the residual prediction models, and the second prediction value by combining the first prediction values in a manner that the large weight is set to the first prediction value calculated by the prediction model with which a small absolute value of the residual prediction error is obtained. Therefore, prediction can be performed in a manner that a plurality of models is combined according to data for prediction.

Moreover, four kinds of models, CART, MARS, TreeNet, and Neural Networks are used as prediction models. However, the other prediction models can be used in the present invention.

Furthermore, the residual prediction model is used to predict the residual prediction error or the absolute error. However, in the present invention, the residual prediction model can be used to predict the other residuals.

For example, the residual prediction model can be used to predict the square of the residuals. Further, when the residual prediction model is created, data causing residual that is larger than certain value may be excluded. Furthermore, the residual prediction model can be used to predict characteristics of estimate values other than residual, such as reliability of the estimate values, and one estimate value may be selected from the estimate values based on the characteristics predicted by the residual prediction model.

Moreover, the second prediction value is calculated in a manner that the large weight is set to the first prediction value calculated by the prediction model with which a small absolute value of the residual prediction error is obtained, and that the weight for each first prediction value is determined as sum of the weights becomes “unity”. However, in the present invention, the second prediction value can be calculated by other algorithms based on the first prediction value.

According to the present invention, a more accurate prediction value can be obtained even if a data space has a regional variation.

Moreover, the second prediction value can be obtained by weighting to the first prediction value according to local characteristics of a data space for prediction, so that a more accurate prediction value can be obtained no matter data spaces are different in character by location.

Furthermore, the second prediction value can be obtained by selecting an appropriate prediction model according to local characteristics of a data space for prediction, so that a more accurate prediction value can be obtained no matter data spaces are different in character by location.

Moreover, the second prediction value is calculated by combining the prediction models, so that a more accurate prediction value can be obtained.

Furthermore, local characteristics of a data space for prediction can be accurately reflected on the combination of the prediction models so that accurate residual prediction can be performed.

Moreover, it is relatively easy to change the number of the prediction models to be combined and the algorithm used for each prediction model and residual prediction model, so that the expandability and maintainability of the prediction apparatus can be improved.

Furthermore, it is relatively easy to change the algorithm used for each prediction model and residual prediction model, so that the expandability and maintainability of the prediction apparatus can be improved.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An apparatus for predicting a price of an object, comprising:
a prediction-model storing unit
that stores a first prediction model which includes a first predetermined parameter and which is used to output a first price as a first target price based on a series of prediction variables each of which is relevant to the first target price, and
that stores a second prediction model which is different from the first prediction model, which includes a second predetermined parameter, and which is used to output a second price as the first target price based on the series of prediction variables;
a residual-prediction-model creating unit
that receives a plurality of verification data sets each of which includes an actual first target price as a target price and an actual first series of values as the series of prediction variables,
that outputs the first price based on the actual first series of values by using the first prediction model, for each of the verification data sets,
that outputs the second price based on the actual first series of values by using the second prediction model, for each of the verification data sets,
that verifies the first prediction model by calculating a first absolute error between the actual first target price and the first price output based on the actual first series of values, for each of the verification data sets,
that verifies the second prediction model by calculating a second absolute error between the actual first target price and the second price output based on the actual first series of values, for each of the verification data sets,
that creates a first residual prediction model which is used to output the first absolute error based on the series of prediction variables and which includes a parameter adjusted based on the first absolute error and the actual first series of values, and
that creates a second residual prediction model which is used to output the second absolute error based on the series of prediction variables and which includes a parameter adjusted based on the second absolute error and the actual first series of values; and
a prediction-value calculating unit
that receives an actual second series of values as the series of prediction variables,
that outputs the first price based on the actual second series of values by using the first prediction model, wherein the first price output is a first predicted price,
that outputs the second price based on the actual second series of values by using the second prediction model, wherein the second price output is a second predicted price,
that outputs the first absolute error based on the actual second series of values by using the first residual prediction model, wherein the first absolute error output is a first prediction error,
that outputs the second absolute error based on the actual second series of values by using the second residual prediction model, wherein the second absolute error output is a second prediction error,
that sets a first weight and a second weight to the first predicted price and the second predicted price respectively based on the first prediction error and the second prediction error, and
that combines the weighted first predicted price and the weighted second predicted price, wherein the combined value is a final prediction price of the object.

2. The apparatus for predicting a price of an object according to claim 1, further comprising:
a model creating unit
that receives a plurality of learning data sets each of which includes an actual third target price as the target price and an actual third series of values as the series of prediction variables,
that creates the first prediction model by adjusting the first predetermined parameter based on the actual third target price and the actual third series of values, and
that creates the second prediction model by adjusting the second predetermined parameter based on the actual third target price and the actual third series of values.

3. The apparatus for predicting a price of an object according to claim 2, wherein the plurality of verification data sets is newer than the plurality of learning data sets.

4. The apparatus for predicting a price of an object according to claim 2, wherein each of the first prediction model, the second prediction model, the first residual prediction model, and the second residual prediction model is a model using a binary tree or a neural network.

5. The apparatus for predicting a price of an object according to claim 1, wherein the first weight is set larger than the second weight if the first prediction error is smaller than the second prediction error.

6. The apparatus for predicting a price of an object according to claim 1, wherein
the prediction-model storing unit further stores a third prediction model which includes a third predetermined parameter and which is used to output a third price as the first target price based on the series of prediction variables;
the residual-prediction-model creating unit
outputs the third price based on the actual first series of values by using the third prediction model, for each of the verification data sets,
verifies the third prediction model by calculating a third absolute error between the actual first target price and the third price output based on the actual first series of values, for each of the verification data sets, and
creates a third residual prediction model which is used to output the third absolute error based on the series of prediction variables and which includes a parameter adjusted based on the third absolute error and the actual first series of values;
the prediction-value calculating unit
outputs the third price based on the actual second series of values by using the third prediction model, wherein the third price output is a third predicted price,
outputs the third absolute error based on the actual second series of values by using the third residual prediction model, wherein the third absolute error output is a third prediction error,
sets the first weight, the second weight, and a third weight to the first predicted price, the second predicted price, and the third predicted price respectively based on the first prediction error, the second prediction error, and the third prediction error,
combines the weighted first predicted price, the weighted second predicted price, and the weighted third predicted price, wherein the combined value is the second prediction price, and
the first weight is set at “unity,” and the second weight and the third weight are set at “zero,” if the first prediction error is smallest of all the prediction errors.

7. The apparatus for predicting a price of an object according to claim 6, wherein each of the third prediction model and the third residual prediction model is a model using a binary tree or a neural network.

8. The apparatus for predicting a price of an object according to claim 1, further comprising a residual prediction-model storing unit that stores the first residual prediction model and the second residual prediction model.

9. The apparatus for predicting a price according to claim 1, further comprising an output unit that outputs the second predicted price in a visible form.

10. The apparatus for predicting a price of an object according to claim 1, wherein the final prediction price is a price of real estate.

11. The apparatus for predicting a price of an object according to claim 1, wherein the final prediction price is a price of agricultural produce.

12. A method for predicting a price of an object, comprising:
reading a first prediction model which is stored in a prediction-model storing unit, which includes a first predetermined parameter, and which is used to output a first price as a first target price based on a series of prediction variables each of which is relevant to the first target price;
reading a second prediction model which is stored in the prediction-model storing unit, which is different from the first prediction model, which includes a second predetermined parameter, and which is used to output a second price as the first target price based on the series of prediction variables;
receiving a plurality of verification data sets each of which includes an actual first target price as a target price and an actual first series of values as the series of prediction variables;
outputting the first price based on the actual first series of values by using the first prediction model, for each of the verification data sets;
outputting the second price based on the actual first series of values by using the second prediction model, for each of the verification data sets;
verifying the first prediction model by calculating a first absolute error between the actual first target price and the first price output based on the actual first series of values, for each of the verification data sets;
verifying the second prediction model by calculating a second absolute error between the actual first target price and the second price output based on the actual first series of values, for each of the verification data sets;
creating a first residual prediction model which is used to output the first absolute error based on the series of prediction variables and which includes a parameter adjusted based on the first absolute error and the actual first series of values;
creating a second residual prediction model which is used to output the second absolute error based on the series of prediction variables and which includes a parameter adjusted based on the second absolute error and the actual first series of values;
receiving an actual second series of values as the series of prediction variables;
outputting the first price based on the actual second series of values by using the first prediction model, wherein the first price output is a first predicted price;
outputting the second price based on the actual second series of values by using the second prediction model, wherein the second price output is a second predicted price;
outputting the first absolute error based on the actual second series of values by using the first residual prediction model, wherein the first absolute error output is a first prediction error;
outputting the second absolute error based on the actual second series of values by using the second residual prediction model, wherein the second absolute error output is a second prediction error;
setting a first weight and a second weight to the first predicted price and the second predicted price respectively based on the first prediction error and the second prediction error; and
combining the weighted first predicted price and the weighted second prediction price, wherein the combined value is a final prediction price of the object.

13. The method for predicting a price of an object according to claim 12, further comprising:
receiving a plurality of learning data sets each of which includes an actual third target price as the target price and an actual third series of values as the series of prediction variables,
creating the first prediction model by adjusting the first predetermined parameter based on the actual third target price and the actual third series of values, and
creating the second prediction model by adjusting the second predetermined parameter based on the actual third target price and the actual third series of values.

14. The method for predicting a price of an object according to claim 13, wherein
the plurality of verification data sets is newer than the plurality of learning data sets, and
each of the first prediction model, the second prediction model, the first residual prediction model, and the second residual prediction model is a model using a binary tree or a neural network.

15. A computer program, embodied in a computer readable medium, for predicting a price of an object that contains instructions which when executed on a computer cause the computer to execute:
reading a first prediction model which is stored in a prediction-model storing unit, which includes a first predetermined parameter, and which is used to output a first price as a first target price based on a series of prediction variables each of which is relevant to the first target price;
reading a second prediction model which is stored in a prediction-model storing unit, which is different from the first prediction model, which includes a second predetermined parameter, and which is used to output a second price as the first target price based on the series of prediction variables;
receiving a plurality of verification data sets each of which includes an actual first target price as a target price and an actual first series of values as the series of prediction variables;
outputting the first price based on the actual first series of values by using the first prediction model, for each of the verification data sets;
outputting the second price based on the actual first series of values by using the second prediction model, for each of the verification data sets;
verifying the first prediction model by calculating a first absolute error between the actual first target price and the first price output based on the actual first series of values, for each of the verification data sets;
verifying the second prediction model by calculating a second absolute error between the actual first target price and the second price output based on the actual first series of values, for each of the verification data sets;
creating a first residual prediction model which is used to output the first absolute error based on the series of prediction variables and which includes a parameter adjusted based on the first absolute error and the actual first series of values;
creating a second residual prediction model which is used to output the second absolute error based on the series of prediction variables and which includes a parameter adjusted based on the second absolute error and the actual first series of values;
receiving an actual second series of values as the series of prediction variables;
outputting the first price based on the actual second series of values by using the first prediction model, wherein the first price output is a first predicted price;
outputting the second price based on the actual second series of values by using the second prediction model, wherein the second price output is a second predicted price;
outputting the first absolute error based on the actual second series of values by using the first residual prediction model, wherein the first absolute error output is a first prediction error;
outputting the second absolute error based on the actual second series of values by using the second residual prediction model, wherein the second absolute error output is a second prediction error;
setting a first weight and a second weight to the first predicted price and the second predicted price respectively based on the first prediction error and the second prediction error; and
combining the weighted first predicted price and the weighted second predicted price, wherein the combined value is a final prediction price of the object.

16. The computer program, embodied in a computer readable medium, for predicting a price of an object according to claim 15, that contains instructions which when executed on a computer cause the computer to further execute:
receiving a plurality of learning data sets each of which includes an actual third target price as the target price and an actual third series of values as the series of prediction variables,
creating the first prediction model by adjusting the first predetermined parameter based on the actual third target price and the actual third series of values, and
creating the second prediction model by adjusting the second predetermined parameter based on the actual third target price and the actual third series of values.

17. The computer program, embodied in a computer readable medium, for predicting a price of an object according to claim 16, wherein
the plurality of verification data sets is newer than the plurality of learning data sets, and
each of the first prediction model, the second prediction model, the first residual prediction model, and the second residual prediction model is a model using a binary tree or a neural network.

18. A computer readable recording medium that stores a computer program for predicting the price of an object, that contains instructions which when executed on a computer cause the computer to execute:
reading a first prediction model which is stored in the prediction-model storing unit, which includes a first predetermined parameter, and which is used to output a first price as a first target price based on a series of prediction variables each of which is relevant to the first target price;
reading a second prediction model which is stored in the prediction-model storing unit, which is different from the first prediction model, which includes a second predetermined parameter, and which is used to output a second price as the first target price based on the series of prediction variables;
receiving a plurality of verification data sets each of which includes an actual first target price as a target price and an actual first series of values as the series of prediction variables;
outputting the first price based on the actual first series of values by using the first prediction model, for each of the verification data sets;
outputting the second price based on the actual first series of values by using the second prediction model, for each of the verification data sets;
verifying the first prediction model by calculating a first absolute error between the actual first target price and the first price output based on the actual first series of values, for each of the verification data sets;
verifying the second prediction model by calculating a second absolute error between the actual first target price and the second price output based on the actual first series of values, for each of the verification data sets;
creating a first residual prediction model which is used to output the first absolute error based on the series of prediction variables and which includes a parameter adjusted based on the first absolute error and the actual first series of values;
creating a second residual prediction model which is used to output the second absolute error based on the series of prediction variables and which includes a parameter adjusted based on the second absolute error and the actual first series of values;
receiving an actual second series of values as the series of prediction variables;
outputting the first price based on the actual second series of values by using the first prediction model, wherein the first price output is a first predicted price;
outputting the second price based on the actual second series of values by using the second prediction model, wherein the second price output is a second predicted price;
outputting the first absolute error based on the actual second series of values by using the first residual prediction model, wherein the first absolute error output is a first prediction error;
outputting the second absolute error based on the actual second series of values by using the second residual prediction model, wherein the second absolute error output is a second prediction error;
setting a first weight and a second weight to the first predicted price and the second predicted price respectively based on the first prediction error and the second prediction error; and
combining the weighted first predicted price and the weighted second predicted price, wherein the combined value is a final prediction price of the object.

19. The computer readable recording medium that stores a computer program for predicting the price of an object, according to claim 18, that contains instructions which when executed on a computer cause the computer to further execute:
receiving a plurality of learning data sets each of which includes an actual third target price as the target price and an actual third series of values as the series of prediction variables,
creating the first prediction model by adjusting the first predetermined parameter based on the actual third target price and the actual third series of values, and
creating the second prediction model by adjusting the second predetermined parameter based on the actual third target price and the actual third series of values.

20. The computer readable recording medium that stores a computer program for predicting the price of an object, according to claim 19, wherein
the plurality of verification data sets is newer than the plurality of learning data sets, and
each of the first prediction model, the second prediction model, the first residual prediction model, and the second residual prediction model is a model using a binary tree or a neural network.

21. The method for predicting a price according to claim 12, wherein the final prediction price is a price of real estate.

22. The method for predicting a price according to claim 12, wherein the final prediction price is a price of agricultural produce.

23. The computer program, embodied in a computer readable medium, for predicting a price of an object according to claim 15, wherein the final prediction price is a price of real estate.

24. The computer program, embodied in a computer readable medium, for predicting a price of an object according to claim 15, wherein the final prediction price is a price of agricultural produce.

25. The computer readable recording medium that stores a computer program for predicting the price of an object, according to claim 18, wherein the final prediction price is a price of real estate.

26. The computer readable recording medium that stores a computer program for predicting the price of an object, according to claim 18, wherein the final prediction price is a price of agricultural produce.
